(19) United States
(12) Patent Application Publication
(10) Pub. No.: US 2026/0313645 A1
(43) Pub. Date: Oct. 8, 2026

(54) FEEDBACK IDENTIFIER MANAGEMENT AND UNUSED TRANSMISSION OCCASION (UTO) UPLINK CONTROL INFORMATION (UCI) FOR UPLINK SHARED CHANNELS IN SUBBAND FULL DUPLEX (SBFD) DEPLOYMENTS

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US); Mohammed JABI, San Diego, CA (US)

(21) Appl. No.: 19/637,711

(22) Filed: Apr. 2, 2026

Related U.S. Application Data
(60) Provisional application No. 63/783,474, filed on Apr. 4, 2025.

(51) Int. Cl. H04W 72/1268; H04L 1/18; H04L 5/14; H04W 72/21

(52) U.S. Cl. CPC H04W 72/1268; H04L 1/18; H04L 5/14; H04W 72/21

(57) ABSTRACT

This disclosure provides methods, components, devices and systems for feedback identifier management and unused transmission occasion (UTO) uplink control information (UCI) for uplink shared channels in subband full duplex (SBFD) deployments. For example, a user equipment (UE) may be configured with a configuration (e.g., Configuration 1) and a grant of resources for uplink transmissions. The UE may determine which transmission occasions (TOs) are valid (e.g., SBFD or non-SBFD symbols for Configuration 1). The UE may increment hybrid automatic repeat request (HARQ) identifiers (IDs) for valid TOs, and may not increment HARQ IDs for invalid TOs. The UE may generate a bitmap for an unused transmission occasion (UTO) uplink control information (UCI) message, but may exclude bits corresponding to invalid TOs (e.g., and may include bits corresponding to valid TOs). The UE may transmit the uplink transmissions as described herein via the selected valid TOs and the grant.

### CROSS REFERENCE

This present Application for Patent claims the benefit of U.S. Provisional Patent Application No. 63/783,474 by IBRAHIM et al., entitled “FEEDBACK IDENTIFIER MANAGEMENT AND UNUSED TRANSMISSION OCCASION (UTO) UPLINK CONTROL INFORMATION (UCI) FOR UPLINK SHARED CHANNELS IN SUBBAND FULL DUPLEX (SBFD) DEPLOYMENTS,” filed Apr. 4, 2025, assigned to the assignee hereof, and which is expressly incorporated by reference in its entirety herein.

### TECHNICAL FIELD

This disclosure relates generally to wireless communication, and more specifically to systems, devices, methods, and techniques associated with feedback identifier management and unused transmission occasion (UTO) uplink control information (UCI) for uplink shared channels in subband full duplex (SBFD) deployments.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

In some examples, a wireless communications system may support subband full duplex (SBFD) operations, but may not be equipped with or configured to perform related operations based on the SBFD operations.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving control signaling indicating a symbol type corresponding to a valid type of transmission occasion, the symbol type comprising one of a subband full duplex (SBFD) symbol type or a non-SBFD symbol type, selecting a subset of transmission occasions of a plurality of candidate transmission occasions in accordance with a grant of uplink resources and a SBFD configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, transmitting an unused transmission occasion (UTO) uplink control information (UCI) message indicating one or more unused transmission occasions of the subset of transmission occasions of the valid transmission occasions, and transmitting one or more of a plurality of uplink transmissions via one or more of the valid transmission occasions.

A UE for wireless communications is described. The UE may include a processing system that includes processor circuitry and memory circuitry that stores code. The processing system may be configured to cause the UE to receive control signaling indicating a symbol type corresponding to a valid type of transmission occasion, the symbol type comprising one of a subband full duplex (SBFD) symbol type or a non-SBFD symbol type, select a subset of transmission occasions of a plurality of candidate transmission occasions in accordance with a grant of uplink resources and a SBFD configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, transmit an unused transmission occasion (UTO) uplink control information (UCI) message indicating one or more unused transmission occasions of the subset of transmission occasions of the valid transmission occasions, and transmit one or more of a plurality of uplink transmissions via one or more of the valid transmission occasions.

Another UE for wireless communications is described. The UE may include means for receiving control signaling indicating a symbol type corresponding to a valid type of transmission occasion, the symbol type comprising one of a subband full duplex (SBFD) symbol type or a non-SBFD symbol type, selecting a subset of transmission occasions of a plurality of candidate transmission occasions in accordance with a grant of uplink resources and a SBFD configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, transmitting an unused transmission occasion (UTO) uplink control information (UCI) message indicating one or more unused transmission occasions of the subset of transmission occasions of the valid transmission occasions, and transmitting one or more of a plurality of uplink transmissions via one or more of the valid transmission occasions.

A non-transitory computer-readable medium storing code for wireless communications is described. The code may include instructions executable by one or more processors to receive control signaling indicating a symbol type corresponding to a valid type of transmission occasion, the symbol type comprising one of a subband full duplex (SBFD) symbol type or a non-SBFD symbol type, select a subset of transmission occasions of a plurality of candidate transmission occasions in accordance with a grant of uplink resources and a SBFD configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, transmit an unused transmission occasion (UTO) uplink control information (UCI) message indicating one or more unused transmission occasions of the subset of transmission occasions of the valid transmission occasions, and transmit one or more of a plurality of uplink transmissions via one or more of the valid transmission occasions.

Some examples of the method, user equipment (UEs), and non-transitory computer-readable medium described herein may further include operations, features, means, or instructions for incrementing an HARQ identifier value for the subset of transmission occasions, and refraining from incrementing the HARQ identifier value for a second subset of transmission occasions designated as invalid transmission occasions based at least in part on each of the second subset of transmission occasions occurring in non-SBFD symbols in accordance with the first configuration corresponding to the SBFD symbol type, or each of the second subset of transmission occasions occurring in SBFD symbols in accordance with the first configuration corresponding to the non-SBFD symbol type.

Some examples of the method, user equipment (UEs), and non-transitory computer-readable medium described herein may further include operations, features, means, or instructions for receiving second control signaling comprising a SBFD configuration indicating that uplink transmissions are to occur in one of SBFD symbols or non-SBFD symbols, and receiving third control signaling comprising the grant of uplink resources on an uplink shared channel for a plurality of uplink transmissions, the uplink resources overlapping with one or more SBFD symbols.

Some examples of the method, user equipment (UEs), and non-transitory computer-readable medium described herein may further include operations, features, means, or instructions for selecting the subset of transmission occasions may be based on a symbol type of a first transmission occasion of the set of multiple candidate transmission occasions.

Some examples of the method, user equipment (UEs), and non-transitory computer-readable medium described herein may further include operations, features, means, or instructions for generating a bitmap corresponding to the UTO-UCI message, the bitmap indicating the one or more unused transmission occasions of the subset of transmission occasions of the valid transmission occasions, where the bitmap excludes a set of multiple invalid transmission occasions.

A method for wireless communications by a network entity is described. The method may include transmitting control signaling indicating a symbol type corresponding to a valid type of transmission occasion, the symbol type comprising one of an SBFD symbol type or a non-SBFD symbol type, receiving an unused transmission occasion (UTO) uplink control information (UCI) message indicating one or more unused transmission occasions of a subset of transmission occasions of a plurality of candidate transmission occasions in accordance with a grant of uplink resources and a SBFD configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, or each of the subset of transmission occasions occurring in non-SBFD symbols, and receiving one or more of a plurality of uplink transmissions via one or more of the valid transmission occasions.

A network entity for wireless communications is described. The network entity may include a processing system that includes processor circuitry and memory circuitry that stores code. The processing system may be configured to cause the network entity to transmit control signaling indicating a symbol type corresponding to a valid type of transmission occasion, the symbol type comprising one of an SBFD symbol type or a non-SBFD symbol type, receive an unused transmission occasion (UTO) uplink control information (UCI) message indicating one or more unused transmission occasions of a subset of transmission occasions of a plurality of candidate transmission occasions in accordance with a grant of uplink resources and a SBFD configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, or each of the subset of transmission occasions occurring in non-SBFD symbols. and receive one or more of a plurality of uplink transmissions via one or more of the valid transmission occasions.

Another network entity for wireless communications is described. The network entity may include means for transmitting control signaling indicating a symbol type corresponding to a valid type of transmission occasion, the symbol type comprising one of an SBFD symbol type or a non-SBFD symbol type, receiving an unused transmission occasion (UTO) uplink control information (UCI) message indicating one or more unused transmission occasions of a subset of transmission occasions of a plurality of candidate transmission occasions in accordance with a grant of uplink resources and a SBFD configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, or each of the subset of transmission occasions occurring in non-SBFD symbols, and receiving one or more of a plurality of uplink transmissions via one or more of the valid transmission occasions.

A non-transitory computer-readable medium storing code for wireless communications is described. The code may include instructions executable by one or more processors to transmit control signaling indicating a symbol type corresponding to a valid type of transmission occasion, the symbol type comprising one of an SBFD symbol type or a non-SBFD symbol type, receive an unused transmission occasion (UTO) uplink control information (UCI) message indicating one or more unused transmission occasions of a subset of transmission occasions of a plurality of candidate transmission occasions in accordance with a grant of uplink resources and a SBFD configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, or each of the subset of transmission occasions occurring in non-SBFD symbols. and receive one or more of a plurality of uplink transmissions via one or more of the valid transmission occasions.

Some examples of the method, network entities, and non-transitory computer-readable medium described herein may further include operations, features, means, or instructions for transmitting second control signaling comprising a SBFD configuration indicating that uplink transmissions are to occur in one of SBFD symbols or non-SBFD symbols, and transmitting third control signaling comprising the grant of uplink resources on an uplink shared channel for a plurality of uplink transmissions, the uplink resources overlapping with one or more SBFD symbols.

In some examples of the method, network entities, and non-transitory computer-readable medium described herein, the subset of transmission occasions may be designated as valid transmission occasions based on a symbol type of a first transmission occasion of the set of multiple candidate transmission occasions.

In some examples of the method, network entities, and non-transitory computer-readable medium described herein, the UTO-UCI message includes a bitmap indicating the one or more unused transmission occasions of the subset of transmission occasions of the valid transmission occasions, and the bitmap excludes a set of multiple invalid transmission occasions.

### BRIEF DESCRIPTION OF THE DRAWINGS

FIG. 1 shows an example of a wireless communication system.

FIG. 2 shows an example of a signaling configuration that supports feedback identifier management and unused transmission occasion (UTO) uplink control information (UCI) for uplink shared channels in subband full duplex (SBFD) deployments.

FIG. 3 shows an example of a communication scheme that supports feedback identifier management and UTO-UCI for uplink shared channels in SBFD deployments.

FIG. 4 shows an example of a communication scheme that supports feedback identifier management and UTO-UCI for uplink shared channels in SBFD deployments.

FIG. 5 shows an example of a process flow that supports feedback identifier management and UTO-UCI for uplink shared channels in SBFD deployments.

FIG. 6 shows a block diagram of a processing system that supports feedback identifier management and UTO-UCI for uplink shared channels in SBFD deployments.

FIG. 7 shows a diagram of a system including a device that supports feedback identifier management and UTO-UCI for uplink shared channels in SBFD deployments.

FIG. 8 shows a block diagram of a processing system that supports feedback identifier management and UTO-UCI for uplink shared channels in SBFD deployments.

FIG. 9 shows a diagram of a system including a device that supports feedback identifier management and UTO-UCI for uplink shared channels in SBFD deployments.

FIGS. 10 and 11 show flowcharts illustrating methods that support feedback identifier management and UTO-UCI for uplink shared channels in SBFD deployments.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a wireless communications system may support subband full duplex (SBFD) communications in which uplink and downlink communications may be transmitted simultaneously (e.g., via one or more uplink subbands and one or more downlink subbands in a single slot). The UE may be configured with configured grant (CG) physical uplink shared channel (PUSCH) transmissions, or dynamic grant (DG) PUSCH, or a downlink control information (DCI) may schedule multiple uplink transmissions or repetitions, among other examples. Multiple uplink transmissions may be scheduled across multiple transmission occasions (TOs), which may be located in SBFD symbols (e.g., symbols that include uplink and downlink subbands), and non-SBFD symbols (e.g., uplink or downlink symbols). The network entity may configure the UE with a first configuration (e.g., configuration 1), or a second configuration (e.g., configuration 2). Configuration 1 may indicate that the UE is only to transmit via SBFD symbols, or via non-SBFD symbols (e.g., but not via both types of symbols). Configuration 2 may indicate that the UE is permitted to transmit via both SBFD symbols and non-SBFD symbols. The UE may determine which TOs are valid TOs, and may only transmit uplink signaling via valid TOs in accordance with the configuration type. However, some additional procedures (e.g., unused transmission occasion (UTO) uplink control information (UCI) reporting, hybrid automatic repeat request (HARQ) identifier (ID) tracking, or the like) may be impacted by which TOs are valid and which are not. Without a mechanism to determine how such operations are to be performed based on valid TO selection, such procedures may fail. For example, without accurate HARQ ID tracking, feedback signaling and processes may fail, resulting in increased retransmissions, increased signaling overhead, decreased reliability of wireless signaling, and increased system latency. UTO-UCI reporting that is not based on a consistent procedure for generating the UTO-UCI, resources may be wasted, throughput may decrease, system latency may increase, and user experience may be negatively impacted.

Aspects of the subject matter described in this disclosure relate to techniques for HARQ ID tracking, UTO-UCI reporting, and uplink transmissions in SBFD deployments. For example, a UE may be configured with a configuration (e.g., Configuration 1) and a grant of resources for uplink transmissions (e.g., a CG-PUSCH, DC-PUSCH, multi-transmission DCIs, etc.). The UE may determine which TOs are valid (e.g., SBFD only or non-SBFD symbols for Configuration 1). The UE may increment HARQ IDs for valid TOs, and may not increment HARQ IDs for invalid TOs. The UE may generate a bitmap for a UTO-UCI, but may exclude bits corresponding to invalid TOs (e.g., and may include bits corresponding to valid TOs). The UE may transmit the uplink transmissions as described herein via the selected valid TOs and the grant.

Particular aspects of the subject matter described in this disclosure can be implemented to realize one or more of the following potential advantages. In some examples, by performing HARQ ID tracking and UTO-UCI reporting based on a set of rules or conditions as described herein, HARQ ID tracking may be effective and consistent, resulting in more effective feedback signaling and improved throughput. UTO-UCI reporting based on a bitmap corresponding to valid TOs (e.g., and excluding invalid TOs) may result in more effective use of available system resources, improved throughput, and improved user experience.

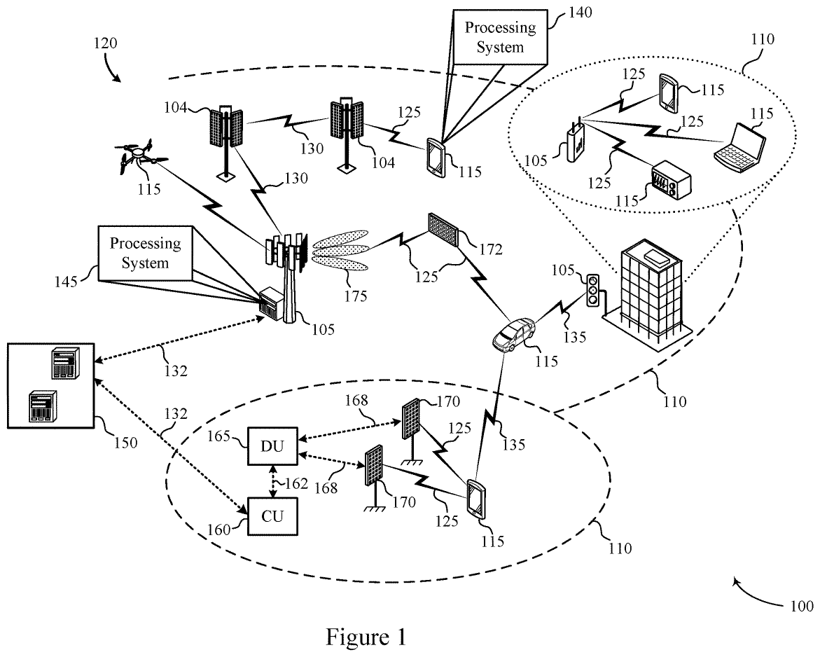

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for feedback identifier management and UTO-UCI for uplink shared channels in SBFD deployments. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support improved throughput, more efficient use of system resources, improved communication between devices, and improved user experience.

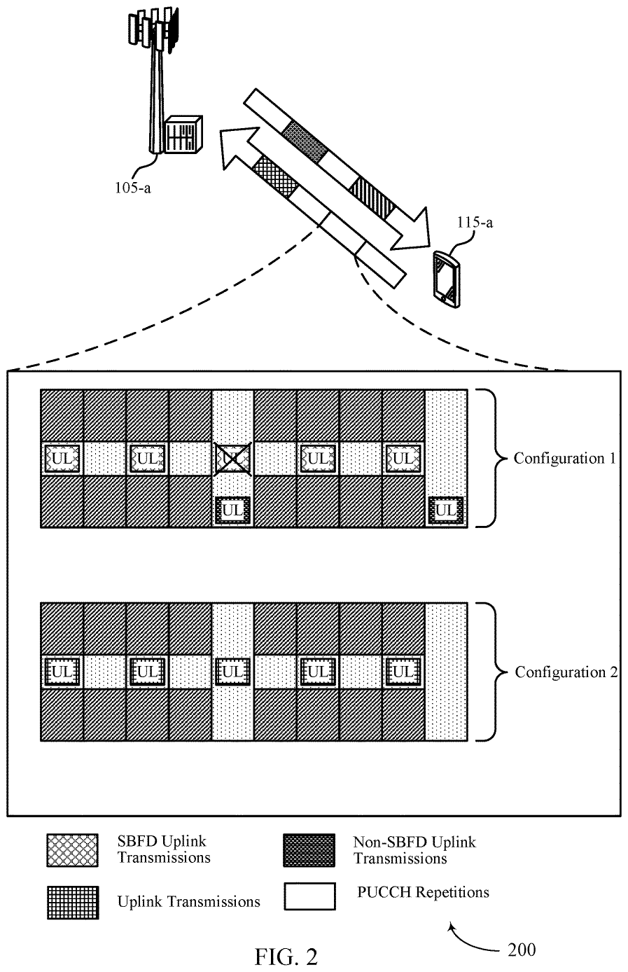

FIG. 2 shows an example of a communication scheme 200 that supports feedback identifier management and UTO-UCI for uplink shared channels in SBFD deployments. The communication scheme 200 may implement, or be implemented by, aspects of the wireless communications system 100. For example, a UE (such as, a UE 115-a) and a network entity (such as, a network entity 105-a), which may be examples of corresponding devices described with reference to FIG. 1, may communicate in accordance with the communication scheme 200.

The wireless communications system may support wireless communications via uplink occasions (such as, via physical uplink shared channel (PUSCH) resources, such as transmission occasions (TOs)). The UE 115-a may receive control signaling scheduling uplink transmissions via uplink resources (such as, PUSCH resources).

Some uplink occasions may be located in uplink or flexible slots (such as, uplink slots). Some uplink occasions (such as, second uplink occasions) may be located in uplink resources (such as, an uplink subband) in an SBFD slots (such as, which includes both uplink resources and downlink resources). In some examples, first uplink occasions may be referred to as non-SBFD uplink occasions, and second uplink occasions may be referred to as SBFD uplink occasions (e.g., or vice versa). Some wireless devices may not support SBFD modes of operation, and may only be capable of transmitting random access signaling via the first uplink occasions. Other UEs (such as, SBFD-aware UEs) may be capable of transmitting uplink signaling via the first uplink occasions, and via the second uplink occasions.

Full duplex communications may include in-band full duplex (IBFD) (e.g., transmission and reception at the same time and frequency resources, where downlink and uplink share the same IBFD time and frequency resources with full or partial overlap), and subband FDD (e.g., flexible duplex), in which case transmission and reception occur at the same time, but on different frequency resources (e.g., DL resources are separated from UL resources in the frequency domain). Full duplex operations may also include subband full duplex (SBFD) operations, in which case non-overlapping uplink and downlink subbands are configured. Uplink resources and downlink resources may be partially or completely overlapping. In some examples, the network entity may simultaneously transmit DL signaling and receive UL signaling via a SBFD slot. In some examples, a UE may simultaneously transmit UL signaling and receive DL signaling via an SBFD slot.

In some examples, transmission and reception in SBFD operations may occur across slots. SBFD transmission and receptions across SBFD and non-SBFD symbols may be supported in accordance with a first configuration (Configuration 1), a second Configuration (Configuration 2), or both. For UL transmissions and DL receptions across SBFD symbols and non-SBFD symbols in different slots (each transmission/reception within a slot has either all SBFD or all non-SBFD symbols) for an SBFD aware UE, the SBFD-aware UE is provided with one of the configurations (e.g., via control signaling). According to Configuration 1, the transmission and reception or receptions (e.g., across multiple slots) are restricted to SBFD symbols only, or non-SBFD symbols only. According to Configuration 2, the transmissions or receptions can be in SBFD symbols and non-SBFD symbols. SBFD aware UEs may be configured with Configuration 2 on a per uplink or downlink BWP basis. The configuration for DL BWPs at least applies to PDSCH reception with the DL BWP. The configuration for UL BWP applies to PUCCH and PUSCH transmissions with the UL BWP. For SRS, configuration 1 may be applicable. Configuration 1 may be considered a default capability. Support of configuration 2 may be subject to UE capability. The configuration of Configuration 1 or 2 for DL BWPs may apply to PDSCH reception within a downlink BWP.

In some examples, transmission via UL TOs may be determined based on whether a TO is valid. For instance, under Configuration 1, the UE 115-a is only to transmit via valid TOs, and a TO in an SBFD slot may not be considered valid if configuration 1 restricts the UE 115-a to transmissions via non-SBFD slots. Similarly, a TO in a non-SBFD slot may not be considered valid if configuration 1 restricts the UE 115-a to transmission via SBFD slots.

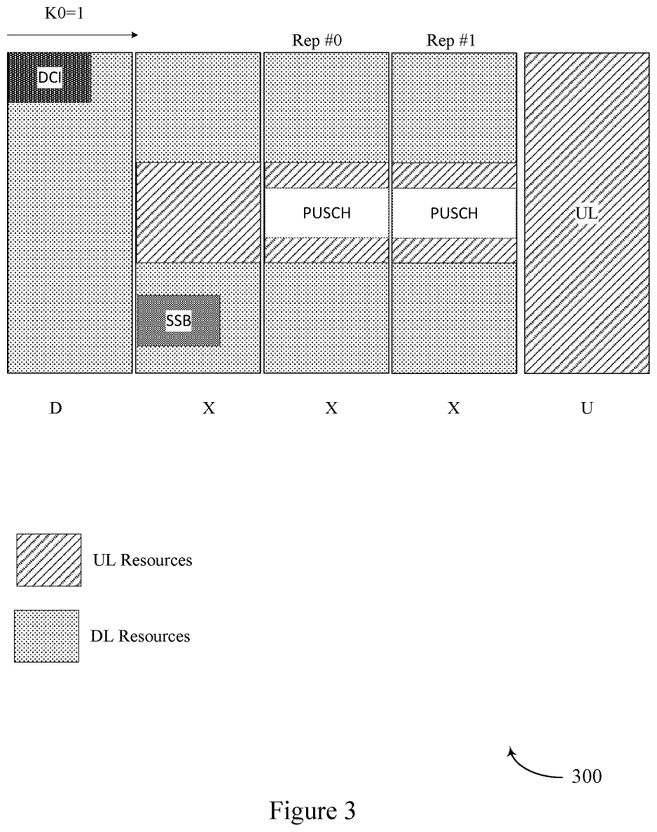

In some examples, as described in greater detail with reference to FIGS. 3 through 5, one or more additional procedures (e.g., UTO-UCI reporting, HARQ ID management, etc.) may also be determined based on the determination of valid TOs.

FIG. 3 shows an example of a communication scheme 300 that supports feedback identifier management and UTO-UCI for uplink shared channels in SBFD deployments. The communication scheme 300 may implement, or be implemented by, aspects of the wireless communications system 100, or the communication scheme 200. For example, a UE (such as, a UE 115) and a network entity (such as, a network entity 105), which may be examples of corresponding devices described with reference to FIGS. 1 and 2, may communicate in accordance with the communication scheme 300.

For Configuration 1, transmissions/receptions are restricted to SBFD symbols only or non-SBFD symbols only, and a valid symbol type (or a valid TO) is determined as follows. For semi-statically configured transmissions/receptions without activation DCI (e.g., periodic or semi-persistent (SP) sounding reference signal (SRS) signaling, semi-persistent CSI reporting, periodic or SP CSI-RSs, configured grant (CG) type 1, etc.), the valid symbol type is explicitly configured by RRC signaling. For dynamically scheduled transmissions/receptions (e.g., PDSCH repetition, PUSCH repetition, multiple PUSCH transmissions scheduled by a single DCI, etc.) the valid symbol type is determined based on the symbol type of the first transmission/reception occasion indicated by scheduling DCI. It is not expected that the first transmission/reception occasion indicated by scheduling DCI is mapped to both SBFD and non-SBFD symbols. For type 2 CG PUSCH, SPS, PDSCH, among other examples, the valid symbol type for type 2 CG PUSCH is determined based on the symbol type of the first CG PUSCH associated with activation DCI, and the valid symbol type for SPS PDSCH is determined based on the symbol type of the first SPS PDSCH associated with activation DCI.

For transmission or reception in SBFD operations across slots (e.g., for PUSCH transmissions via valid PUSCH TOs), the validity of a symbol type may be determined by the UE that has been configured with configuration 1. For example, the UE may be semi-statically configured per UL BWP (e.g., via control signaling such as RRC signaling) with Configuration 1 or Configuration 2. In the case of configuration 2, the valid symbol may then be determined based on PUSCH type and one or more rules. For example, for CG_PUSCH type 1, semi-static signaling (e.g., an RRC parameter) may indicate a valid symbol type (e.g., SBFD indicating restriction to SBFD symbols, or non-SBFD indicating restriction to non-SBFD symbols). In such examples, the valid symbol type for Type 1 CG PUSCH may be configured via an RRC parameter such as rrc-ConfiguredUplinkGrant in ConfiguredGrantConfig. For CG-PUSCH Type 2, the first TO of a set of TOs may determine the valid symbol type (e.g., SBFD symbols or non-SBFD symbols). For dynamic grant (DG) PUSCH repetition type A and multiple PUSCHs scheduled by a single DCI, the first TO may determine the valid symbol type. Thus, having determined the type of symbol that is considered valid (e.g., which TOs are valid), the UE may determine which TOs to use for scheduled uplink transmissions. Similar techniques may be applied for reception occasions and reception symbols. For invalid symbol types, the UE may drop one or more transmissions (e.g., for PUSCH repetition B with either CG_PUSCH type 1 and type 2, or DG-PUSCH, the UE may drop transmission in invalid symbols).

For UL transmissions and DL receptions across SBFD symbols and non-SBFD symbols in different slots (each transmission/reception within a slot has either all SBFD or all non-SBFD symbols) with Configuration 1, the UE may perform slot counting if available. For example, for PUSCH repetition type A with available slot counting, A-SRS with available slot counting, TB processing over multi-slot PUSCH (TBoMS) and PUCCH repetitions, UE postpones transmissions in the invalid symbol type. For CG PUSCH with neither TBoMS nor PUSCH repetition type A with available slot counting, and SPS PDSCH, Periodic or SP SRS, Periodic or SP CSI-RS, Periodic or SP PUCCH, SP-CSI on PUSCH, PUSCH repetition type A without available slot counting, multi-PUSCH or multi PDSCH scheduled by a single DCI, and PDSCH repetitions, transmissions/receptions in the invalid symbol type are dropped. In some examples, a valid configured PUSCH grant may be determined based on whether the PUSCH grant is colliding with DL symbols indicated by RRC parameters such as by tdd-UL-DL-ConfigurationCommon or tdd-UL-DL-ConfigurationDedicated if provided, or whether the PUSCH grant is colliding with a symbol of an SS/PBCH block with an index provided by ssb-PositionsInBurst.

However, without a mechanism or set of rules to define UE behavior, the UE may not be able to perform one or more additional procedures accurately based on having selected valid TOs (e.g., and ignored or dropped invalid TOs that might otherwise correspond with some procedures). For example, CG-PUSCH TOs may exclude invalid TOs where a UE does not transmit a PUSCH due to collision of the PUSCH with DL symbols indicated by tdd-UL-DL-ConfigurationCommon or tdd-UL-DL-ConfigurationDedicated if provided, or with symbols of an SS/PBCH block with an index provided by ssb-PositionsInBurst. The UE may transmit a UTO-UCI message indicating unused TOs. A bit value (e.g., 0) in the UTO-UCI report may indicate one or more TOs via which the UE will transmit (e.g., one or more CG-PUSCH transmissions that the UE will send), and another bit value (e.g., 1) may indicate one or more TOs via which the UE will not transmit (e.g., one or more CG-PUSCH transmissions that the UE will not send). When the UE indicates via the UTO-UCI a value of 1 for a TO (e.g., a CG-PUSCH TO), the UE continues to indicate the value of 1 for the CG-PUSCH TO by UTO-UCI multiplexed in subsequent CG-PUSCH transmission, and the UE may not transmit CG-PUSCH transmissions in the CG-PUSCH TO. However, if the bitmap of the UTO-UCI corresponds to all configured TOs, but some of the TOs are considered invalid, then the UTO-UCI may not be accurately encoded or decoded, resulting in inefficient use of available system resources, decreased throughput, increased latency, and poor user experience. Further, if the UE and the network entity do not generate and interpret the UTO-UCI in the same manner (e.g., based on which TOs are valid and which TOs are invalid), then the UTO-UCI reporting may fail.

Additionally, or alternatively, if the UE does not consistently track HARQ feedback and HARQ IDs for TOs, then the UE may ineffectively track HARQ signaling, resulting in an unnecessary increase in signaling overhead, reduced reliability of wireless signaling, increased system latency, and poor user experience.

Techniques described herein support one or more procedures based on the restriction of some (e.g., invalid) symbol types. Restriction of some symbol types (e.g., in SBFD deployments) may result in failed procedures (e.g., such as HARQ ID tracking and UTO-UCI reporting, and slot type for power and evolved non-standalone dual connectivity (EN-DC) and carrier aggregation (CA) deployments, among other examples).

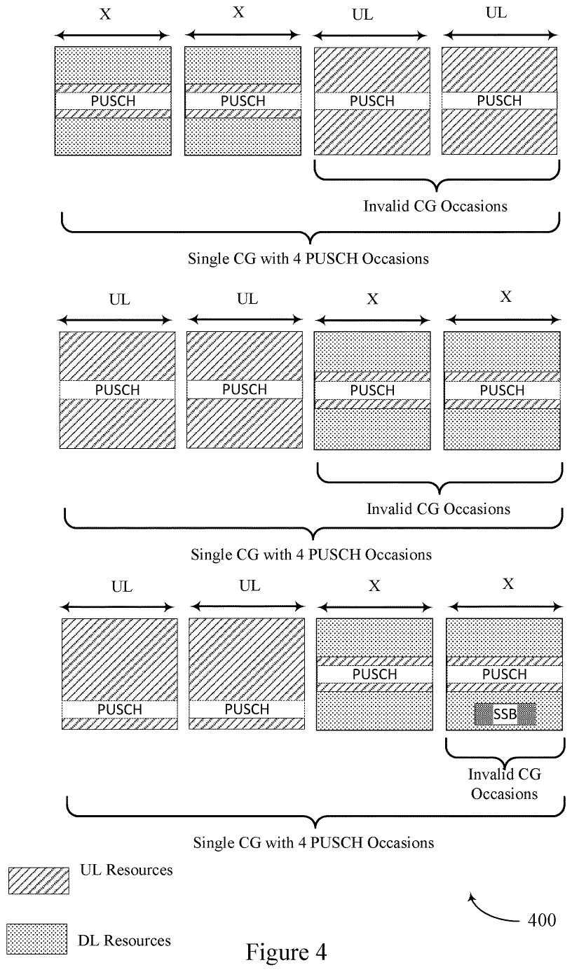

FIG. 4 shows an example of a communication scheme 400 that supports feedback identifier management and UTO-UCI for uplink shared channels in SBFD deployments. The communication scheme 400 may implement, or be implemented by, aspects of the wireless communications system 100, the communication scheme 200, or the communication scheme 300. For example, a UE (such as, a UE 115) and a network entity (such as, a network entity 105), which may be examples of corresponding devices described with reference to FIGS. 1 through 3, may communicate in accordance with the communication scheme 300.

When a UE is provided with configuration 1 for uplink transmissions across SBFD and non-SBFD symbols, and configured with multiple CG-PUSCHs within a period, the UE may perform HARQ ID tracking as follows. For Type-1 CG PUSCH configured semi-statically with valid symbol type SBFD, or Type-2 CG PUSCH with a first transmission occasion that is an SBFD symbol, then a valid CG-PUSCH occasion is not colliding with non-SBFD symbols (DL, UL, FL) and not colliding with a symbol of SSB blocks in SBFD symbols, in which case a HARQ ID is not incremented for invalid CG-PUSCH occasions within the CG period (e.g., the HARQ ID is incremented for valid CG-PUSCH occasions within the CG period). For Type-1 CG PUSCH configured with a valid symbol type of non-SBFD, or Type-2 CG PUSCH with a first occasion that is a non-SBFD symbol, then a valid CG-PUSCH occasion is not colliding with SBFD symbols nor DL symbols and not colliding with a symbol of SSB blocks, in which case the HARQ ID is not incremented or invalid CG-PUSCH occasions (e.g., the HARQ ID is incremented for valid CG-PUSCH occasions). In some examples, when the UE is provided with configuration 2 for UL transmissions across SBFD and non-SBFD symbols and configured with multiple CG-PUSCHs within a CG-period, a valid CG-PUSCH occasion is one that is not colliding with DL symbol (not configured as SBFD) nor SSB symbol.

For multiple PUSCHs in a CG period, when the UE is provided with configuration 2, CG occasions in SBFD symbols configured in DL symbols by TDD-UL-DL common may be considered valid. CG occasions in SBFD symbols overlapping with SSBs may be considered invalid. The starting RB of a PUSCH occasion in an SBFD symbol may be determined based on semi-static RB-offsets per CG-configuration. For example, the starting SBFD RB may be defined as

$$R {B}_{start}^{SBFD} = {RB}_{start}^{ULSB} + ( R {B}_{start}^{non - SBFD} + R {B}_{offset}^{SBFD} ) mod {N}_{ULSB}^{size} .$$

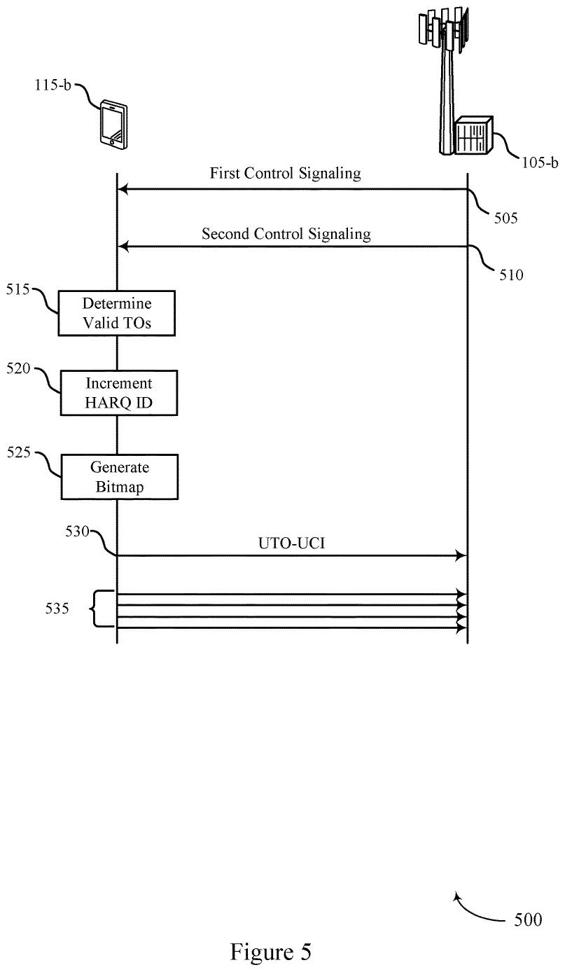

FIG. 5 shows an example of a process flow 500 that supports feedback identifier management and UTO-UCI for uplink shared channels in SBFD deployments. The process flow 500 may implement, or be implemented by, aspects of the wireless communications system 100, the communication scheme 200, the communication scheme 300, or the communication scheme 400. For example, a UE 115-b and a network entity 105-b, which may be examples of corresponding devices described with reference to FIGS. 1 through 4.

The UE 115-b may be configured (e.g., via the first control signaling at 505) with configuration 1 for uplink transmission across SBFD and non-SBFD symbols. The second control signaling (e.g., received at 510) may schedule resources for uplink transmissions at 535 (e.g., a CG-PUSCH indicating CG-PUSCH TOs). At 515, the UE 115-b may determine none or more valid TOs (e.g., based on Configuration 1, as described with reference to FIGS. 1 through 4).

At 520, the UE 115-b may increment the HARQ ID for valid TOs (and may not increment the HARQ ID for invalid TOs).

At 525, the UE 115-b may generate a bitmap for a UTO-UCI, and at 530, the UE 115-b may transmit the UTO-UCI. The UE 115-b may exclude bits from the bitmap that correspond to invalid TOs. The UTO-UCI may thus indicate whether valid TOs are utilized or unutilized (e.g., if the UE 115-b will transmit uplink signaling via valid TOs.

The UE may be configured for reporting UTO-UCI of subsequent CG-PUSCH TOs. For Type-1 CG PUSCH configured semi-statically with valid symbol type ‘non-SBFD’ or Type-2 CG PUSCH with first transmission occasion is ‘non-SBFD’, the UE excludes invalid CG-PUSCH TOs where the UE doesn't transmit PUSCH due to overlapping with a SBFD symbols, DL symbols or a symbol of SSB blocks. For Type-1 CG PUSCH configured with valid symbol type ‘SBFD’ or Type-2 CG PUSCH with first occasion is ‘SBFD’, the UE excludes invalid CG-PUSCH TOs (e.g., from the bitmap), and the UE may not transmit PUSCH due to overlapping with non-SBFD symbol (DL, UL or FL) or overlapping with a symbol of SSB blocks. When the UE is provided with configuration 2 for UL transmission across SBFD and non-SBFD symbols, and with UE reporting of a UTO-UCI of subsequent CG-PUSCH TOs, the UE excludes invalid CG-PUSCH TOs from the bitmap for TOs that the UE will not transmit PUSCH due to overlapping with DL symbol (not configured as SBFD) or SSB.

In some examples, the UE 115-b may manage a slot type for power of EN-DC and CA deployments. If the UE is not provided tdd-UL-DL-ConfigurationCommon for an MCG, the UE may determine a transmission power for the SCG using a defined threshold transmission power. If at least one symbol of a slot of the MCG that has been indicated as uplink or flexible or indicated as a downlink and configured as an SBFD symbol by tdd-UL-DL-ConfigurationCommon or tdd-UL-DL-ConfigurationDedicated overlap with the subframe of the SCG, then the UE may determine a transmission power for the SCG using a value for the threshold transmission power, otherwise, the UE may determine the transmission power for the SCG without considering the threshold transmission power.

If the UE is provided with semi-static-mode2 for nrdc-PCmode-FR1 or for nrdc-PCmode-FR2, and if the UE is not provided with tdd-UL-DL-ConfigurationCommon for the MCG or SCG, the UE may determine a transmission power for the MCG or for the SCG using a defined threshold transmission power. If at least one symbol of the slot of the MCG or of the SCG that is indicated as uplink or flexible or indicated as downlink and configured as an SBFD symbol by tdd-UL-DL-ConfigurationCommon and tdd-UL-DL-ConfigurationDedicated, if provided, overlaps with a symbol for any ongoing transmission overlapping with the slot of the SCG or the MCG, respectively, then the UE may determine a power for the transmission on the SCG or the MCG overlapping with the slot through using a value for a threshold transmission power.

At 535, the UE 115-b may transmit the multiple uplink transmission via valid TOs in accordance with the grant of resources (and via the TOs that are used and not indicated in the UTO-UCI).

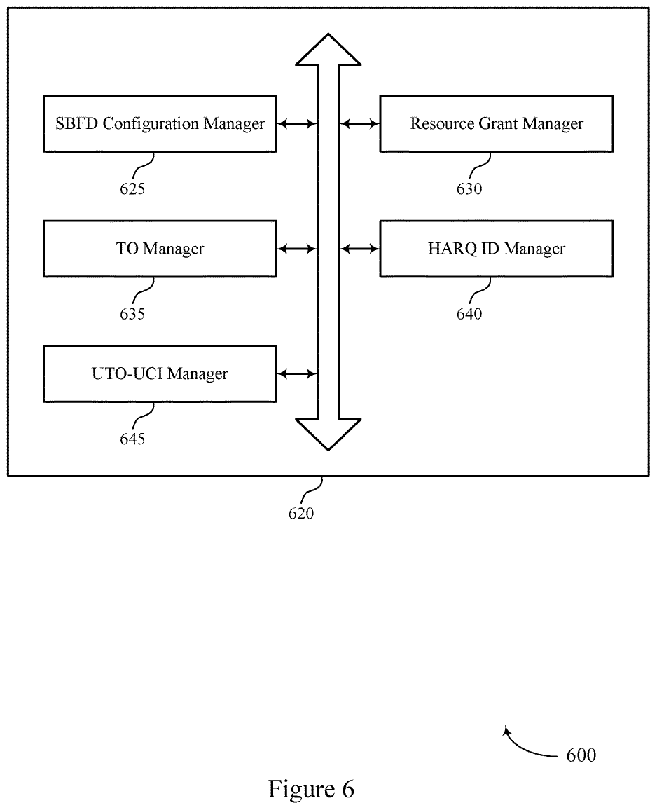

FIG. 6 shows an example of a processing system 620 that supports feedback identifier management and UTO-UCI for uplink shared channels in SBFD deployments. A processing system 620 may be an example of a processing system 140 (such as of a UE 115) and may include an SBFD configuration manager 625, a resource grant manager 630, a TO manager 635, an HARQ ID manager 640, a UTO-UCI manager 645, or any combination thereof. A processing system 620, or various component thereof, may be an example of means for performing (such as a means for causing a UE 115 to perform) various techniques described herein.

The SBFD configuration manager 625 may be configured to cause the UE 115 to receive first control signaling including a subband full duplex (SBFD) configuration indicating that uplink transmissions are to occur in one of SBFD symbols or non-SBFD symbols. The resource grant manager 630 may be configured to cause the UE 115 to receive second control signaling including a grant of uplink resources on an uplink shared channel for a set of multiple uplink transmissions, the uplink resources overlapping with one or more SBFD symbols. The TO manager 635 may be configured to cause the UE 115 to select a subset of transmission occasions of a set of multiple candidate transmission occasions in accordance with the grant of uplink resources and the SBFD configuration, where the subset of transmission occasions are designated as valid transmission occasions based on each of the subset of transmission occasions occurring in SBFD symbols, or each of the subset of transmission occasions occurring in non-SBFD symbols in accordance with the SBFD configuration. The HARQ ID manager 640 may be configured to cause the UE 115 to increment an HARQ identifier value for the subset of transmission occasions. The UTO-UCI manager 645 may be configured to cause the UE 115 to transmit an unused transmission occasion (UTO) uplink control information (UCI) message indicating one or more unused transmission occasions of the subset of transmission occasions of the valid transmission occasions. In some examples, the TO manager 635 may be configured to cause the UE 115 to transmit one or more of the set of multiple uplink transmissions via one or more of the valid transmission occasions.

In some examples, the HARQ ID manager 640 may be configured to cause the UE 115 to refrain from incrementing the HARQ identifier value for a second subset of transmission occasions designated as invalid transmission occasions based at least in part on each of the second subset of transmission occasions occurring in non-SBFD symbols in accordance with the first configuration corresponding to the SBFD symbol type, or each of the second subset of transmission occasions occurring in SBFD symbols in accordance with the first configuration corresponding to the non-SBFD symbol type.

In some examples, the TO manager 635 may be configured to cause the UE 115 to receive third control signaling indicating a symbol type corresponding to the valid transmission occasions, the symbol type including one of an SBFD symbol type or a non-SBFD symbol type, where selecting the subset of transmission occasions is based on the subset of transmission occasions being the same type as the indicated symbol type.

In some examples, selecting the subset of transmission occasions is based on a symbol type of a first transmission occasion of the set of multiple candidate transmission occasions.

In some examples, the UTO-UCI manager 645 may be configured to cause the UE 115 to generate a bitmap corresponding to the UTO-UCI message, the bitmap indicating the one or more unused transmission occasions of the subset of transmission occasions of the valid transmission occasions, where the bitmap excludes a set of multiple invalid transmission occasions.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for feedback identifier management and UTO-UCI for uplink shared channels in SBFD deployments.

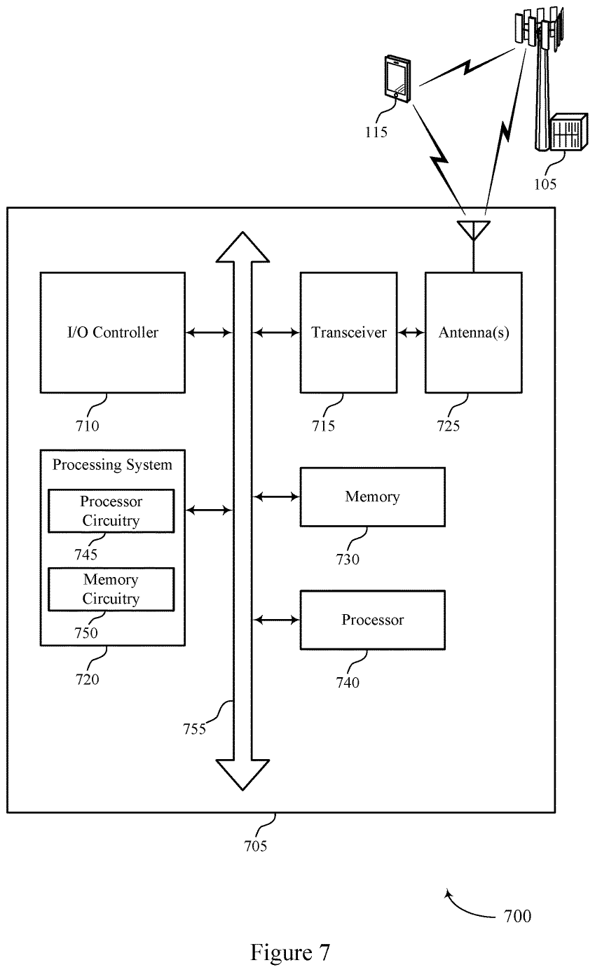

FIG. 7 shows an example of a system 700 including a device 705 that supports feedback identifier management and UTO-UCI for uplink shared channels in SBFD deployments. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 600. For example, the processing system 720 may include processor circuitry 745 and memory circuitry 750 that stores code, and may be configured to cause the device 705 to perform operations that support feedback identifier management and UTO-UCI for uplink shared channels in SBFD deployments. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for HARQ ID tracking and UTO-UCI reporting based on a set of rules or conditions resulting in more effective feedback signaling, improved throughput, more effective use of available system resources, improved throughput, improved coordination between devices, and improved user experience.

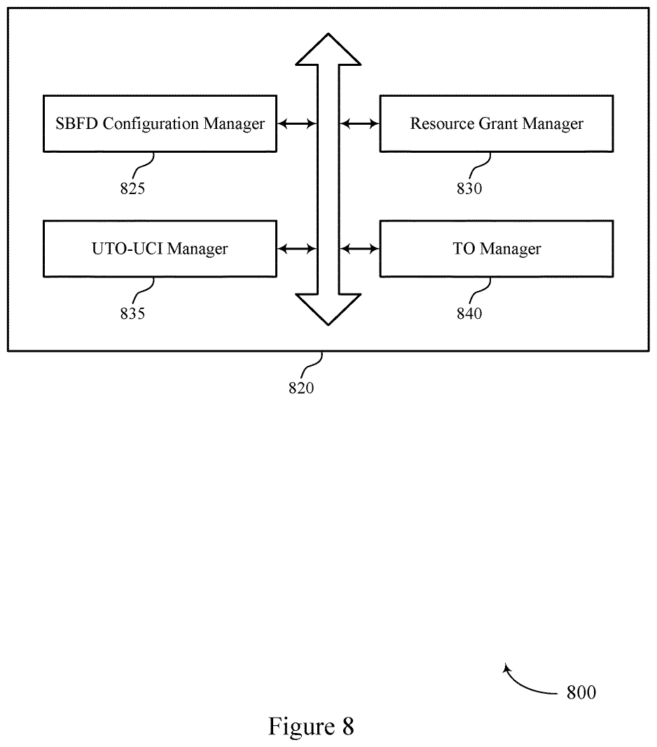

FIG. 8 shows an example of a processing system 820 that supports feedback identifier management and UTO-UCI for uplink shared channels in SBFD deployments. A processing system 820 may be an example of a processing system 145 (such as network entity 105) and may include an SBFD configuration manager 825, a resource grant manager 830, a UTO-UCI manager 835, a TO manager 840, or any combination thereof. A processing system 820, or various component thereof, may be an example of means for performing (such as a means for causing a network entity 105 to perform) various techniques described herein.

The SBFD configuration manager 825 may be configured to cause the network entity 105 to transmit first control signaling including a subband full duplex (SBFD) configuration indicating that uplink transmissions are to occur in one of SBFD symbols or non-SBFD symbols. The resource grant manager 830 may be configured to cause the network entity 105 to transmit second control signaling including a grant of uplink resources on an uplink shared channel for a set of multiple uplink transmissions, the grant of uplink resources overlapping with one or more SBFD symbols. The UTO-UCI manager 835 may be configured to cause the network entity 105 to receive an unused transmission occasion (UTO) uplink control information (UCI) message indicating one or more unused transmission occasions of a subset of transmission occasions of a set of multiple candidate transmission occasions in accordance with the grant of uplink resources and the SBFD configuration, where the subset of transmission occasions are designated as valid transmission occasions based on each of the subset of transmission occasions occurring in SBFD symbols, or each of the subset of transmission occasions occurring in non-SBFD symbols in accordance with the SBFD configuration. The TO manager 840 may be configured to cause the network entity 105 to receive one or more of the set of multiple uplink transmissions via one or more of the valid transmission occasions.

In some examples, the TO manager 840 may be configured to cause the network entity 105 to transmit third control signaling indicating a symbol type corresponding to the valid transmission occasions, the symbol type including one of an SBFD symbol type or a non-SBFD symbol type, where the subset of transmission occasions are designated as valid transmission occasions based on the subset of transmission occasions being the same type as the indicated symbol type.

In some examples, the subset of transmission occasions are designated as valid transmission occasions based on a symbol type of a first transmission occasion of the set of multiple candidate transmission occasions.

In some examples, the UTO-UCI message includes a bitmap indicating the one or more unused transmission occasions of the subset of transmission occasions of the valid transmission occasions, and the bitmap excludes a set of multiple invalid transmission occasions.

A processing system 820 may include or be an example of one or more chips, SoCs, chipsets, packages, components, or devices that individually or collectively constitute or include a processing system. A processing system 820 may interface with other components of a network entity 105. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a network entity 105). Operations described herein with reference to the processing system 820, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 820 for operation in a processing system 820 as described herein, the processing system 820 may support techniques for HARQ ID tracking and UTO-UCI reporting based on a set of rules or conditions resulting in more effective feedback signaling, improved throughput, more effective use of available system resources, improved throughput, improved coordination between devices, and improved user experience.

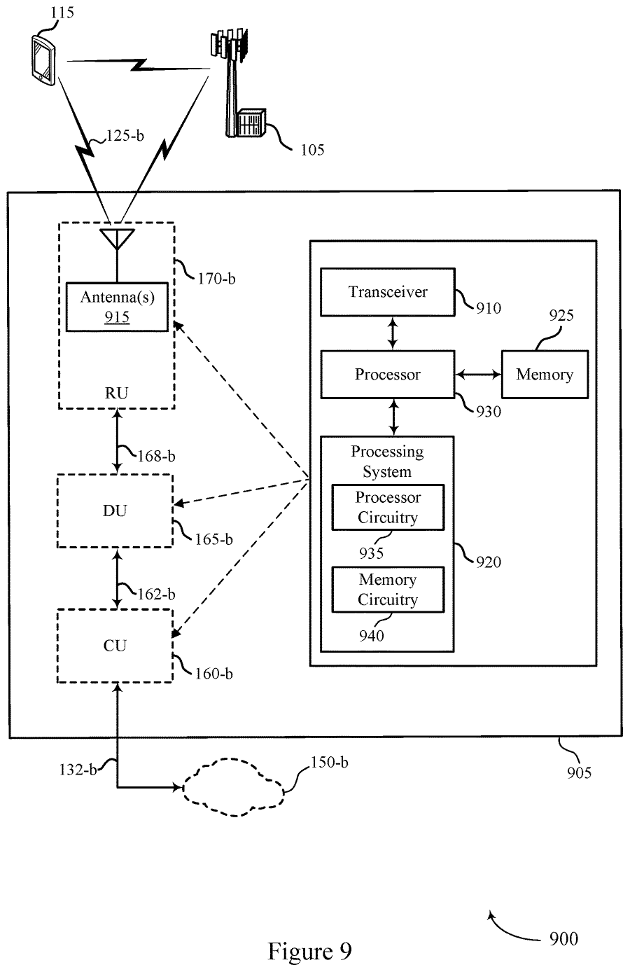

FIG. 9 shows an example of a system 900 including a device 905 that supports feedback identifier management and UTO-UCI for uplink shared channels in SBFD deployments. The device 905 may communicate (such as via one or more wired interfaces or one or more wireless interfaces) with other network devices or network equipment such as a core network 150-b, other network entities 105, UEs 115, or any combination thereof. The device 905 may include components for transmitting and receiving communication, which may include a processing system 920, a transceiver 910, antenna(s) 915, a memory 925, and a processor 930. Components of the device 905 may be coupled (such as operatively, communicatively, functionally, electronically, electrically, in electronic communication) via one or more interfaces.

The transceiver 910 may communicate bi-directionally with another transceiver via wired or wireless links, and may support transmission operations, reception operations, or both, as described herein. The transceiver 910 may include a modem to modulate and demodulate signals, to provide the modulated signals for transmission (such as via antenna(s) 915, via a wired interface), and to demodulate received signals (such as received via antenna(s) 915, received via a wired interface). The transceiver 910 may be operable to support communication via one or more communication links (such as a communication link 125-b, a backhaul link 132-b, a midhaul link 162-b, fronthaul link 168-b).

The processor 930 may be a general-purpose processing component that supports various operations (such as applications) of the device 905. The memory 925 may be a general-purpose storage component that stores code executable by the processor 930. Such code may include instructions that, when executed by the processor 930, cause the device 905 to perform various functions (such as to support an application of the device 905).

For examples in which the device 905 is a network entity 105 in a disaggregated architecture, one or more components of the device 905 may be located at one or more of a CU 160-b, a DU 165-b, or an RU 170-b, one or more of which may include aspects of the processing system 920, the processor 930, the memory 925, or the transceiver 910. Functions of the device 905 may be performed at different components or an operation may be divided between different components (such as different functions being supported by aspects of the CU 160-b, the DU 165-b, or the RU 170-b, the transceiver 910, the processor 930, the memory 925, the processing system 920, or any combination thereof). For example, the processing system 920 may be a component of one or more of the CU 160-b, the DU 165-b, or the RU 170-b. In some examples, interfaces between components of device 905 (such as CU 160-b, DU 165-b, RU 170-b) may support communication at a protocol layer or between protocol layers of a protocol stack.

In some examples, the processing system 920 may manage aspects of communication with the core network 150-b (such as via a backhaul link 132-b). For example, the processing system 920 may manage the transfer of data communication for UEs 115 with a gateway of the core network 150-b. In some examples, the processing system 920 may manage communication with one or more other network entities 105 and may include a controller or scheduler for controlling communication with UEs 115 (such as in cooperation with the one or more other network entities 105). In some examples, the processing system 920 may support an interface (such as X2 interface, Xn interface) to provide communication between network entities 105.

The processing system 920 may be an example of a processing system 145 or a processing system 800. For example, the processing system 920 may include processor circuitry 935 and memory circuitry 940 that stores code, and the processing system 920 may be configured to cause the device 905 to perform operations that support feedback identifier management and UTO-UCI for uplink shared channels in SBFD deployments. Although the processing system 920 is illustrated as a separate component, which may involve a separate chip, chipset, or other module, in some implementations, one or more functions described with reference to the processing system 920 may be supported by or performed by a transceiver 910, antenna(s) 915, a processor 930, memory 925, or any combination thereof, such that a processing system 920 may include one or more of a transceiver 910, antenna(s) 915, a processor 930, memory 925, or any combination thereof. Further, processor circuitry 935 and memory circuitry 940 each may be implemented at the device 905 in accordance with an aggregated architecture, or the processor circuitry 935 and the memory circuitry 940 may be implemented at one or more of a CU 160-b, a DU 165-b, or an RU 170-b in accordance with a disaggregated architecture.

By including or configuring the processing system 920 for operation in the device 905 as described herein, may support techniques for HARQ ID tracking and UTO-UCI reporting based on a set of rules or conditions resulting in more effective feedback signaling, improved throughput, more effective use of available system resources, improved throughput, improved coordination between devices, and improved user experience.

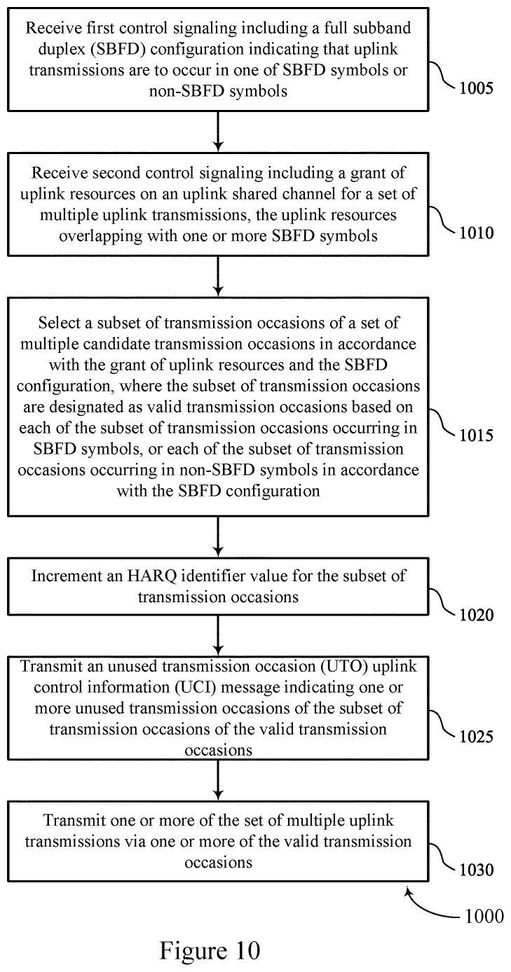

FIG. 10 shows an example of a method 1000 that supports feedback identifier management and UTO-UCI for uplink shared channels in SBFD deployments. Operations of the method 1000 may be performed by a UE or its components (such as using a processing system configured to cause the UE 115 to perform one or more of the operations) as described herein.

At 1005, the method may include receiving first control signaling including a subband full duplex (SBFD) configuration indicating that uplink transmissions are to occur in one of SBFD symbols or non-SBFD symbols. In some examples, aspects of the operations of 1005 may be performed by an SBFD configuration manager 625.

At 1010, the method may include receiving second control signaling including a grant of uplink resources on an uplink shared channel for a set of multiple uplink transmissions, the uplink resources overlapping with one or more SBFD symbols. In some examples, aspects of the operations of 1010 may be performed by a resource grant manager 630.

At 1015, the method may include selecting a subset of transmission occasions of a set of multiple candidate transmission occasions in accordance with the grant of uplink resources and the SBFD configuration, where the subset of transmission occasions are designated as valid transmission occasions based on each of the subset of transmission occasions occurring in SBFD symbols, or each of the subset of transmission occasions occurring in non-SBFD symbols in accordance with the SBFD configuration. In some examples, aspects of the operations of 1015 may be performed by a TO manager 635.

At 1020, the method may include incrementing an HARQ identifier value for the subset of transmission occasions. In some examples, aspects of the operations of 1020 may be performed by an HARQ ID manager 640.

At 1025, the method may include transmitting an unused transmission occasion (UTO) uplink control information (UCI) message indicating one or more unused transmission occasions of the subset of transmission occasions of the valid transmission occasions. In some examples, aspects of the operations of 1025 may be performed by a UTO-UCI manager 645.

At 1030, the method may include transmitting one or more of the set of multiple uplink transmissions via one or more of the valid transmission occasions. In some examples, aspects of the operations of 1030 may be performed by a TO manager 635.

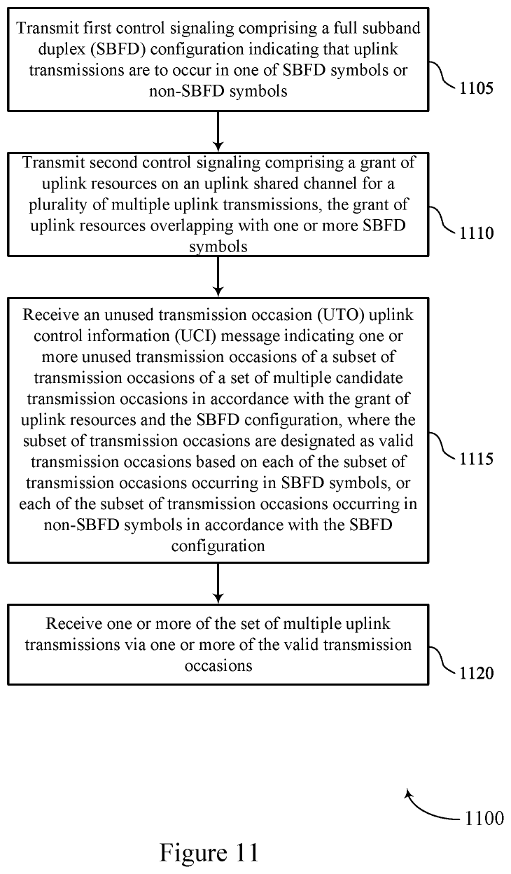

FIG. 11 shows an example of a method 1100 that supports feedback identifier management and UTO-UCI for uplink shared channels in SBFD deployments. Operations of the method 1100 may be performed by a network entity 105 or its components (such as using a processing system configured to cause the network entity to perform one or more operations) as described herein.

At 1105, the method may include transmitting first control signaling including a subband full duplex (SBFD) configuration indicating that uplink transmissions are to occur in one of SBFD symbols or non-SBFD symbols. In some examples, aspects of the operations of 1105 may be performed by an SBFD configuration manager 825.

At 1110, the method may include transmitting second control signaling including a grant of uplink resources on an uplink shared channel for a set of multiple uplink transmissions, the grant of uplink resources overlapping with one or more SBFD symbols. In some examples, aspects of the operations of 1110 may be performed by a resource grant manager 830.

At 1115, the method may include receiving an unused transmission occasion (UTO) uplink control information (UCI) message indicating one or more unused transmission occasions of a subset of transmission occasions of a set of multiple candidate transmission occasions in accordance with the grant of uplink resources and the SBFD configuration, where the subset of transmission occasions are designated as valid transmission occasions based on each of the subset of transmission occasions occurring in SBFD symbols, or each of the subset of transmission occasions occurring in non-SBFD symbols in accordance with the SBFD configuration. In some examples, aspects of the operations of 1115 may be performed by a UTO-UCI manager 835.

At 1120, the method may include receiving one or more of the set of multiple uplink transmissions via one or more of the valid transmission occasions. In some examples, aspects of the operations of 1120 may be performed by a TO manager 840.

Implementation examples are described in the following numbered clauses:

Aspect 1: A method for wireless communications at a UE, comprising: receiving control signaling indicating a symbol type corresponding to a valid type of transmission occasion, the symbol type comprising one of a subband full duplex (SBFD) symbol type or a non-SBFD symbol type, selecting a subset of transmission occasions of a plurality of candidate transmission occasions in accordance with a grant of uplink resources and a SBFD configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, transmitting an unused transmission occasion (UTO) uplink control information (UCI) message indicating one or more unused transmission occasions of the subset of transmission occasions of the valid transmission occasions, and transmitting one or more of a plurality of uplink transmissions via one or more of the valid transmission occasions.

Aspect 2: The method of aspect 1, further comprising: incrementing a HARQ identifier value for the subset of transmission occasions, and refraining from incrementing the HARQ identifier value for a second subset of transmission occasions designated as invalid transmission occasions based at least in part on each of the second subset of transmission occasions occurring in non-SBFD symbols in accordance with the first configuration corresponding to the SBFD symbol type, or each of the second subset of transmission occasions occurring in SBFD symbols in accordance with the first configuration corresponding to the non-SBFD symbol type.

Aspect 3: The method of any of aspects 1 through 2, further comprising: receiving second control signaling comprising a SBFD configuration indicating that uplink transmissions are to occur in one of SBFD symbols or non-SBFD symbols, and receiving third control signaling comprising the grant of uplink resources on an uplink shared channel for a plurality of uplink transmissions, the uplink resources overlapping with one or more SBFD symbols.

Aspect 4: The method of any of aspects 1 through 3, wherein selecting the subset of transmission occasions is based at least in part on a symbol type of a first transmission occasion of the plurality of candidate transmission occasions.

Aspect 5: The method of any of aspects 1 through 4, further comprising: generating a bitmap corresponding to the UTO-UCI message, the bitmap indicating the one or more unused transmission occasions of the subset of transmission occasions of the valid transmission occasions, wherein the bitmap excludes a plurality of invalid transmission occasions.

Aspect 6: A method for wireless communications at a network entity, comprising: transmitting control signaling indicating a symbol type corresponding to a valid type of transmission occasion, the symbol type comprising one of an SBFD symbol type or a non-SBFD symbol type, receiving an unused transmission occasion (UTO) uplink control information (UCI) message indicating one or more unused transmission occasions of a subset of transmission occasions of a plurality of candidate transmission occasions in accordance with a grant of uplink resources and a SBFD configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, or each of the subset of transmission occasions occurring in non-SBFD symbols, and receiving one or more of a plurality of uplink transmissions via one or more of the valid transmission occasions.

Aspect 7: The method of aspect 6, further comprising: second control signaling comprising a SBFD configuration indicating that uplink transmissions are to occur in one of SBFD symbols or non-SBFD symbols, and transmitting third control signaling comprising the grant of uplink resources on an uplink shared channel for a plurality of uplink transmissions, the uplink resources overlapping with one or more SBFD symbols.

Aspect 8: The method of any of aspects 6 through 7, wherein the subset of transmission occasions are designated as valid transmission occasions based at least in part on a symbol type of a first transmission occasion of the plurality of candidate transmission occasions.

Aspect 9: The method of any of aspects 6 through 8, wherein the UTO-UCI message comprises a bitmap indicating the one or more unused transmission occasions of the subset of transmission occasions of the valid transmission occasions, and the bitmap excludes a plurality of invalid transmission occasions.

Aspect 10: A UE for wireless communications, comprising a processing system that includes processor circuitry and memory circuitry that stores code, the processing system configured to cause the UE to perform a method of any of aspects 1 through 5.

Aspect 11: A UE for wireless communications, comprising at least one means for performing a method of any of aspects 1 through 5.

Aspect 12: A non-transitory computer-readable medium storing code for wireless communications, the code comprising instructions executable by one or more processors to perform a method of any of aspects 1 through 5.

Aspect 13: A network entity for wireless communications, comprising a processing system that includes processor circuitry and memory circuitry that stores code, the processing system configured to cause the network entity to perform a method of any of aspects 6 through 9.

Aspect 14: A network entity for wireless communications, comprising at least one means for performing a method of any of aspects 6 through 9.

Aspect 15: A non-transitory computer-readable medium storing code for wireless communications, the code comprising instructions executable by one or more processors to perform a method of any of aspects 6 through 9.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating a symbol type corresponding to a valid type of transmission occasion, the symbol type comprising one of an SBFD symbol type or a non-SBFD symbol type;
select a subset of transmission occasions of a plurality of candidate transmission occasions in accordance with a grant of uplink resources and a subband full duplex (SBFD) configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, or each of the subset of transmission occasions occurring in non-SBFD symbols;
transmit an unused transmission occasion (UTO) uplink control information (UCI) message indicating one or more unused transmission occasions of the subset of transmission occasions of the valid transmission occasions; and
transmit one or more of a plurality of uplink transmissions via one or more of the valid transmission occasions.

2. The UE of claim 1, wherein the one or more processors are individually or collectively further operable to execute the code to cause the UE to:
receive second control signaling comprising a subband full duplex (SBFD) configuration indicating that uplink transmissions are to occur in one of SBFD symbols or non-SBFD symbols; and
receive third control signaling comprising the grant of uplink resources on an uplink shared channel for a plurality of uplink transmissions, the uplink resources overlapping with one or more SBFD symbols.

3. The UE of claim 1, wherein the one or more processors are individually or collectively further operable to execute the code to cause the UE to:
increment a hybrid automatic repeat request (HARQ) identifier value for the subset of transmission occasions; and
refrain from incrementing the HARQ identifier value for a second subset of transmission occasions designated as invalid transmission occasions based at least in part on each of the second subset of transmission occasions occurring in non-SBFD symbols in accordance with the first configuration corresponding to the SBFD symbol type, or each of the second subset of transmission occasions occurring in SBFD symbols in accordance with the first configuration corresponding to the non-SBFD symbol type.

4. The UE of claim 1, wherein selecting the subset of transmission occasions is based at least in part on a symbol type of a first transmission occasion of the plurality of candidate transmission occasions.

5. The UE of claim 1, wherein the one or more processors are individually or collectively further operable to execute the code to cause the UE to:
generate a bitmap corresponding to the UTO-UCI message, the bitmap indicating the one or more unused transmission occasions of the subset of transmission occasions of the valid transmission occasions, wherein the bitmap excludes a plurality of invalid transmission occasions.

6. A network entity, comprising:
one or more memories storing processor-executable code; and
one or more processors coupled with the one or more memories and individually or collectively operable to execute the code to cause the network entity to:
transmit control signaling indicating a symbol type corresponding to a valid type of transmission occasion, the symbol type comprising one of an SBFD symbol type or a non-SBFD symbol type;
receive an unused transmission occasion (UTO) uplink control information (UCI) message indicating one or more unused transmission occasions of a subset of transmission occasions of a plurality of candidate transmission occasions in accordance with an grant of uplink resources and a subband full duplex (SBFD) configuration comprising a first configuration corresponding to the SBFD symbol type or corresponding to the non-SBFD symbol type, wherein the subset of transmission occasions are designated as valid transmission occasions based at least in part on each of the subset of transmission occasions occurring in SBFD symbols, or each of the subset of transmission occasions occurring in non-SBFD symbols; and
receive one or more of a plurality of uplink transmissions via one or more of the valid transmission occasions.

7. The network entity of claim 6, wherein the one or more processors are individually or collectively further operable to execute the code to cause the network entity to:
transmit second control signaling comprising the SBFD configuration indicating that uplink transmissions are to occur in one of SBFD symbols or non-SBFD symbols; and
transmit third control signaling comprising the grant of uplink resources on an uplink shared channel for a plurality of uplink transmissions, the grant of uplink resources overlapping with one or more SBFD symbols.

8. The network entity of claim 6, wherein the subset of transmission occasions are designated as valid transmission occasions based at least in part on a symbol type of a first transmission occasion of the plurality of candidate transmission occasions.

9. The network entity of claim 6, wherein the UTO-UCI message comprises a bitmap indicating the one or more unused transmission occasions of the subset of transmission occasions of the valid transmission occasions, and the bitmap excludes a plurality of invalid transmission occasions.

10. A method for wireless communications at a user equipment (UE), comprising:
receiving control signaling indicating a symbol type corresponding to a valid type of transmission occasions, the symbol type comprising one of an SBFD symbol type or a non-SBFD symbol type;
selecting a subset of transmission occasions of a plurality of candidate transmission occasions in accordance with a grant of uplink resources and a subband full duplex (SBFD) configuration comprising a first configuration corresponding to the SBFD symbol type or to the non-SBFD symbol type, wherein the subset of transmission occasions are designated as valid transmission occasions based at least in part on each of the subset of transmission occasions occurring in SBFD symbols, or each of the subset of transmission occasions occurring in non-SBFD symbols;
transmitting an unused transmission occasion (UTO) uplink control information (UCI) message indicating one or more unused transmission occasions of the subset of transmission occasions of the valid transmission occasions; and
transmitting one or more of a plurality of uplink transmissions via one or more of the valid transmission occasions.

11. The method of claim 10, further comprising:
receiving second control signaling comprising a subband full duplex (SBFD) configuration indicating that uplink transmissions are to occur in one of SBFD symbols or non-SBFD symbols; and
receiving third control signaling comprising the grant of uplink resources on an uplink shared channel for the plurality of uplink transmissions, the uplink resources overlapping with one or more SBFD symbols.

12. The method of claim 10, further comprising:
incrementing a hybrid automatic repeat request (HARQ) identifier value for the subset of transmission occasions; and
refraining from incrementing the HARQ identifier value for a second subset of transmission occasions designated as invalid transmission occasions based at least in part on each of the second subset of transmission occasions occurring in non-SBFD symbols in accordance with the first configuration corresponding to the SBFD symbol type, or each of the second subset of transmission occasions occurring in SBFD symbols in accordance with the first configuration corresponding to the non-SBFD symbol type.

13. The method of claim 10, wherein selecting the subset of transmission occasions is based at least in part on a symbol type of a first transmission occasion of the plurality of candidate transmission occasions.

14. The method of claim 10, further comprising:
generating a bitmap corresponding to the UTO-UCI message, the bitmap indicating the one or more unused transmission occasions of the subset of transmission occasions of the valid transmission occasions, wherein the bitmap excludes a plurality of invalid transmission occasions.
